(19) United States
(12) Patent Application Publication
(10) Pub. No.: US 2008/0082629 A1
(43) Pub. Date: Apr. 3, 2008

(54) Enabling Users to Repeatedly Perform a Sequence of User Actions When Interacting With a Web Server

(75) Inventor: Manikantan Vannadil Puthiyaveettil, Hyderabad (IN)

Correspondence Address: LAW FIRM OF NAREN THAPPETA, 158, PHASE ONE PALM MEADOWS, RAMAGUNDANAHALLI, AIRPORT WHITEFIELD ROAD, BANGALORE, 560043, omitted

(73) Assignee: Oracle International Corporation, Redwood Shores, CA (US)

(21) Appl. No.: 11/560,359

(22) Filed: Nov. 16, 2006

(30) Foreign Application Priority Data
Oct. 3, 2006 (IN) 1831/CHE/2006

(51) Int. Cl. G06F 15/16; G06F 15/173

(52) U.S. Cl. 709/217; 709/226; 709/203

(57) ABSTRACT

Enabling users to repeatedly perform a sequence of user actions when interacting with a web server. The web server initially receives an indication to record a sequence of user actions. On receiving requests (corresponding to user actions) for web pages from a user, the web server translates the requests into commands that are designed to generate the web pages by interfacing with backend systems, which provide the content of the web pages. The translated commands are stored in a memory. On determining a time to replay the same sequence of user actions, the web server, retrieves the commands from the memory and issues the commands to the backend systems.

### RELATED APPLICATIONS

The present application is related to and claims priority from the co-pending India Patent Application entitled, “Enabling Users to Repeatedly Perform a Sequence of User Actions When Interacting With a Web Server”, Serial Number: 1831/CHE/2006, Filed: Oct. 3, 2006, naming the same inventors as in the subject patent application.

### BACKGROUND OF THE INVENTION

1. Field of the Invention

The present disclosure relates to web servers and more specifically to a method and apparatus for enabling users to repeatedly perform a sequence of user actions when interacting with a web server.

2. Related Art

Web servers generally refer to systems, which receive requests for web pages from client systems, and serve the requested web pages (commonly encoded in HTML). In general, a web server receives a URL (uniform resource locator) from a client system and translates the URL to a local identifier that identifies the resource from which the content for the requested web page can be generated. The resource can refer to static content (e.g., a file of a file system) or dynamic content that is generated by execution of a web application. The content thus identified is encoded in the form of a web page and sent to the requesting client system.

A common requirement for a user is to repeatedly perform a sequence of actions requiring sending a sequence of requests and receiving corresponding responses. For example, to check whether a user has received new notifications for a notification service, the user has to request the web page (on the web server) providing the notification service, provide authentication information and request the web page where the new notifications are displayed. These actions may need to be repeatedly performed whenever the user is interested to know the status of new notifications.

It is generally desirable that the burden on users in performing such repeated tasks be reduced.

### BRIEF DESCRIPTION OF THE DRAWINGS

The present invention will be described with reference to the accompanying drawings briefly described below.

FIG. 1 is a block diagram illustrating an example environment in which various aspects of the present invention can be implemented.

FIG. 2 is a flowchart illustrating the manner in which a sequence of user actions performed by a user is recorded in an embodiment of the present invention.

FIG. 3 is a flowchart illustrating the manner in which a web server replays a sequence of recorded user actions in an embodiment of the present invention.

FIG. 4A depicts a web page from which a user indicates to a web server to start recording user actions in one embodiment.

FIGS. 4B, 4C and 4D depict respective web pages illustrating a sequence of user actions that is to be recorded in a web server, in one embodiment.

FIG. 4E depicts a last web page received in response to a sequence of user actions in one embodiment.

FIG. 5 depicts the commands stored to record a sequence of user actions in an embodiment.

FIG. 6A depicts a web page from which a user requests a web server to replay a sequence of recorded user actions in one embodiment.

FIG. 6B depicts a web page received in response to a user request for replaying a sequence of recorded user actions in one embodiment.

FIG. 7A depicts a portion of software code that receives a request from a user for starting the recording of user actions in an embodiment.

FIG. 7B depicts a portion of software code that receives requests for web pages from a user in an embodiment.

FIG. 8 depicts a portion of software code that receives a request from a user for replaying a sequence of recorded user actions in an embodiment.

FIG. 9 is a block diagram illustrating the details of a web server in one embodiment.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

### 1. Overview

An aspect of the present invention enables users to repeatedly perform a sequence of user actions when interacting with a web server. The web server initially receives an indication to record a sequence of user actions. On receiving requests (corresponding to user actions) for web pages from a user, the web server translates the requests into commands that are designed to generate the web pages by interfacing with backend systems, which provide the content of the web pages. The translated commands are stored in a memory. On determining a time to replay the same sequence of user actions, the web server, retrieves the commands from the memory and issues the commands to the backend systems.

According to another aspect of the present invention, the user specifies a schedule time when the sequence of user actions is to be replayed. At the scheduled time, the web server retrieves the commands and issues the commands to the backend systems.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

### 2. Example Environment

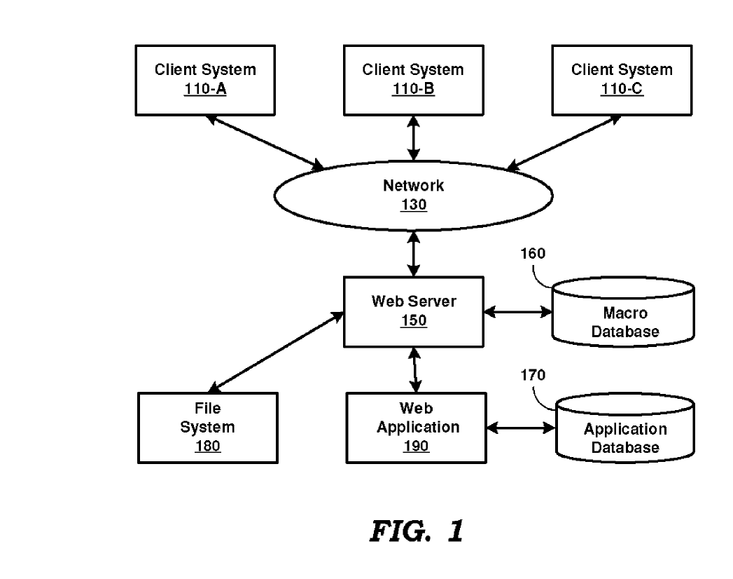

FIG. 1 is a block diagram illustrating an example environment in which various aspects of the present invention can be implemented. The block diagram is shown containing client systems 110A-110C, network 130, web server 150, macro database 160, application database 170, file system 180, and web application 190. Merely for illustration, only representative number/type of systems are shown in the Figure. Many environments often contain many more systems, both in number and type. Each system/device of FIG. 1 is described below in further detail.

Network 130 provides connectivity between various client systems 110A-110C and web server 150. Network 130 may be implemented using protocols such as Internet Protocol (IP) well known in the relevant arts. File system 180 facilitates storage and management of files (such as web pages and images) on a non-volatile storage (such as a hard disk). Each of macro database 160 and application database 170 facilitates storage and retrieval of data using structured queries such as SQL in the case of relational database technologies.

Web Application 190 on execution generates the content of web pages using data from application database 170. Though only a single web application is shown, different web applications may be provided which generate web pages dynamically using data from application database 170 or file system 180 or using data provided by the user, as is well known in the relevant arts. The web applications may be executed in an application server (not shown) provided as a backend to web server 150. The application server facilitates execution of web applications (in general server-side applications) in a controlled manner. The application server may be located in a different physical system from that of the web server. Alternatively, the two servers may be integrated into a single physical unit.

Client system 110A represents a system such as a personal computer, workstation, mobile station, etc., and is used by a user to generate requests for a web page. The requests are represented in the form of URLs and transmitted on network 130. Each URL may be viewed as containing a portion, which identifies the web server, and the parameters specifying the specific web page sought. For example, a URL may be in the format “www.webserver.com/notification.html”, where “www.webserver.com” identifies web server 150 and “notification.html” represents the web page requested by the user. The identifier of the web server is generally translated into a unique IP address by DNS type services, and the URL is delivered in an IP packet having the destination address equaling the IP address and the content including the URL.

Web server 150 receives URLs (in IP packets) specifying the requested web pages, and determines the manner in which the content of the requested web pages is to be generated. The determination may be performed based on the parameter contained in the URL. For example, a parameter with .html extension (as in above example) may indicate that the corresponding file is directly available on file system 180. Other extensions may indicate that the content needs to be generated dynamically by web application 190. Accordingly, web server 150 may send appropriate commands to backend systems such as file system 180 and/or web application 190 to receive the requested web pages. Web server 150 then forwards each web page in the form of IP packets with destination address equaling the IP address of client system 110A (requesting the web page).

As may be appreciated, a user (using client system 110A) may perform a sequence of user actions, potentially using a corresponding number of web pages in succession. Web server 150 facilitates recording (in macro database 160) and replaying of the sequence of user actions according to various aspects of the present invention, as described below in further detail.

### 3. Recording User Actions

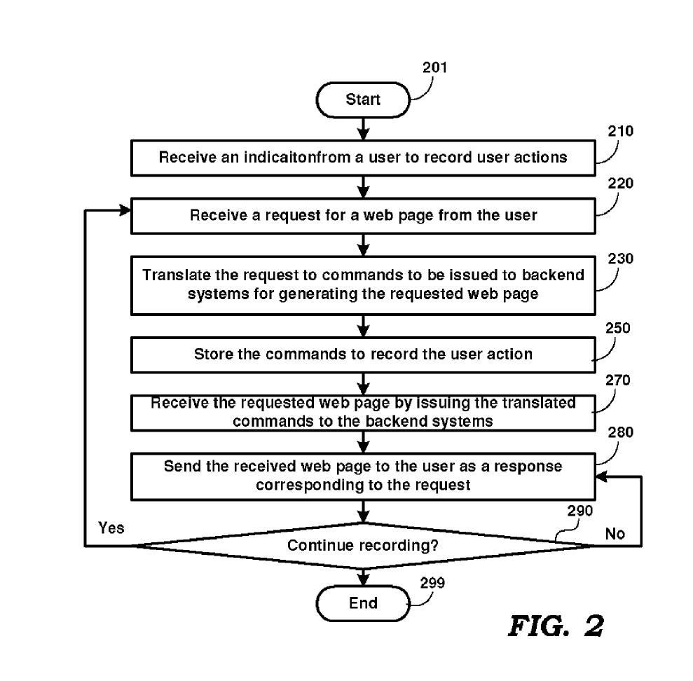

FIG. 2 is a flowchart illustrating the manner in which a sequence of user actions performed by a user is recorded according to various aspects of the present invention. The flowchart is described with respect to FIG. 1 merely for illustration. However, various features can be implemented in other environments also without departing from the scope and spirit of various aspects of the present invention, as will be apparent to one skilled in the relevant arts by reading the disclosure provided herein. The flow chart begins in step 201, in which control immediately passes to step 210.

In step 210, web server 150 receives an indication from a user (e.g., using client systems 110A-110C) to record user actions. The request to start recording the user actions may be indicated by the user by performing a user action such as specifying a pre-defined URL or clicking on a button in a web page associated with recording user actions. The user may also specify a unique name identifying the sequence of user actions to be recorded. Identification of sequences enables the user to record different sequences of user actions and replay them as desired.

In step 220, web server 150 receives a request for a web page from the user from client systems 110A-110C. The request corresponds to a user action that has been performed by the user in the client system. Typically the requests are in the form of URLS specifying the actions to be performed.

In step 230, web server 150 translates the request to commands to be issued to backend systems for generating the requested web page. For example, on receiving the request, web server 150 first determines (e.g., by checking the file extension of the web page requested) the manner in which the requested web page is to be generated and translate the request to data appropriately. For example, the web server 150 may translate “notification.html” to a retrieve command to receive the content in a file “/var/htdocs/path/notification.html” (the filename identifying the web page) if the requested web page is to be retrieved from file system 180.

Alternatively, if the web page is to be generated dynamically by execution of web application 190, the request may be translated into commands, which cause execution of a corresponding web application and generate the requested web page. The commands may identify the web application by name, in addition to providing any input data that may be used by the application. For example, web server 150 on receiving a request in the format “www.webserver.com/login?username=guest&password=pass” translates the request into commands identifying a web application with name “/servlets/login”, the input parameters (“username” and “password”) and the corresponding input values (“guest” and “pass”) that may be used by the web application to generate the requested web page.

In step 250, web server 150 stores the commands to record the user action in macro database 160. In the above example, web server 150 stores “/var/htdocs/path/notification.html” in macro database 160. The data may be stored associated with a name of the sequence (either provided by the user or generated by web server 150).

In step 270, web server 150 receives the requested web page by issuing the translated commands to the backend systems. In the above example, web server 150 uses the translated data “/var/htdocs/path/notification.html” to retrieve the requested web page from file system 180. In step 280, web server 150 sends the received web page to the user as the response corresponding to the request.

In step 290, web server 150 checks whether to continue recording. The continuation of recordation may be based on whether a flag is set (by way of a request) by the user to stop recording. Thus, recoding may be stopped upon a change of status of the flag. Control passes to step 220 if recording is to be continued and to step 299 otherwise. The flow chart ends in step 299.

It may be appreciated that the sequence of recorded user actions may be replayed when the user requires the same sequence of user actions to be performed repeatedly. The manner in which web server 150 replays the sequence of recorded user actions is described in detail below.

### 4. Replaying User Actions

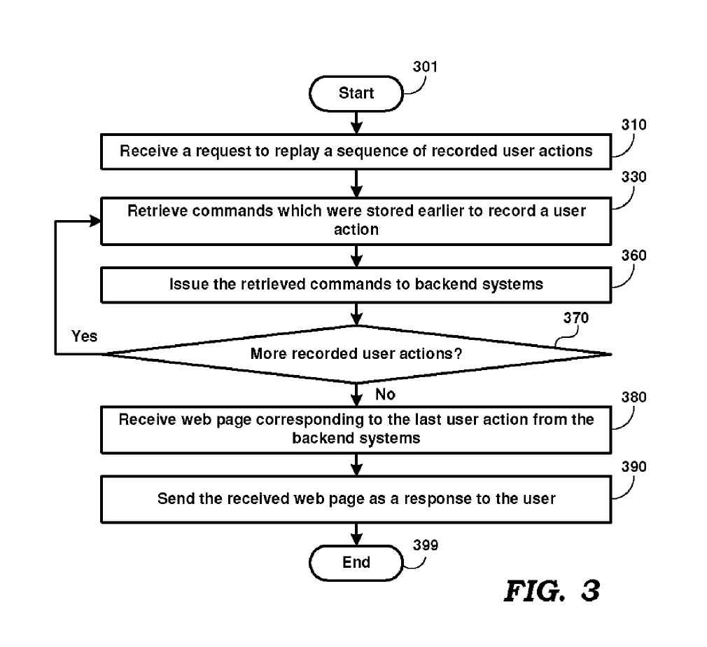

FIG. 3 is a flowchart illustrating the manner in which a web server replays a sequence of recorded user actions according to various aspects of the present invention. The flowchart is described with respect to FIGS. 1 and 2 merely for illustration. However, various features can be implemented in other environments also without departing from various aspects of the present invention, as will be apparent to one skilled in the relevant arts by reading the disclosure provided herein. The flow chart begins in step 301, in which control immediately passes to step 310.

In step 310, web server 150 determines a time to replay a sequence of recorded user actions. The time may be determined in response to a user specifying the specific one of the pre-recorded sequences to be played and/or according to a schedule (every day 9 PM) pre-configured for playing the specific sequence. In step 330, web server 150 retrieves the commands, which are stored earlier to record a user action. The name associated with the sequence stored may be used to identify the commands.

In step 360, web server 150 issues the retrieved commands to the backend systems (i.e., file system 180 and web application 190). The commands may cause retrieval of web pages, which can generally be ignored (except for the last web page, as described below). Alternatively, the response may be examined to determine if the request-responses are proceeding as expected. In case of error, the user may be appropriately notified. The description is continued assuming that no such errors occur, merely to avoid obfuscating the features of the present invention.

In step 370, web server 150 checks whether there are more recorded user actions to be performed in the sequence. Control passes to step 330 if there are more user actions and to step 380 otherwise. Thus, the loop of steps 330, 360 and 370 processes each recorded user action in a single iteration. Alternatively, web server 150 may retrieve commands corresponding to all the recorded user actions belonging to a sequence (identified by a name) and issue the commands to the backend systems sequentially.

In step 380, web server 150 receives the web page corresponding to the last user action from the backend systems in response to the commands sent in step 360. In step 390, web server 150 sends the received web page as a response to the user. The web page thus sent may be substantially similar to the web page generated in step 270 when the last user action was recorded. The flow chart ends in step 399.

It may thus be appreciated that a user is enabled to repeatedly perform a sequence of user actions by recording the sequence of user actions (according to FIG. 2) and then replaying the recorded sequence when desired (according to FIG. 3). The description is continued with an example where a user repeatedly performs a sequence of user actions in an embodiment of the present invention.

### 5. Illustration with Example

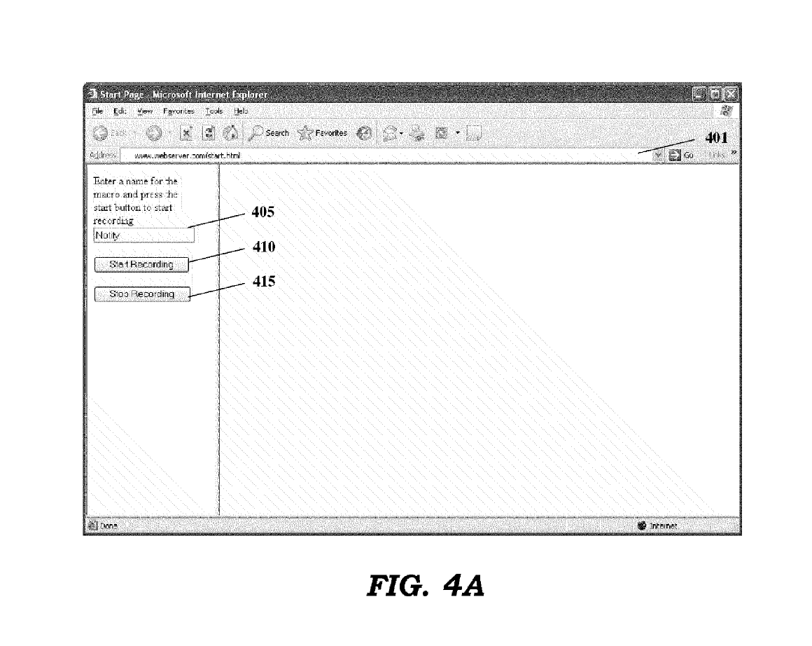

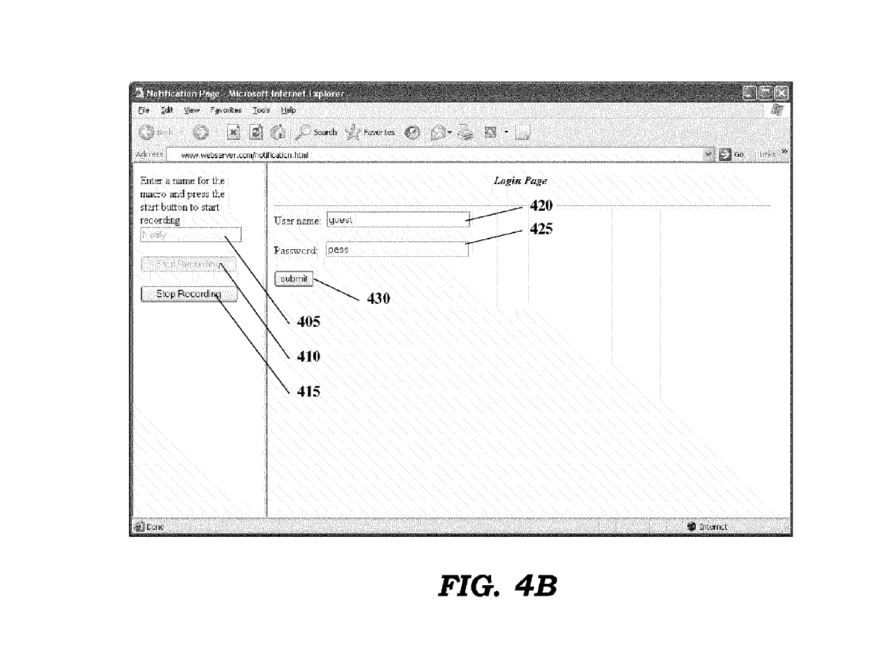

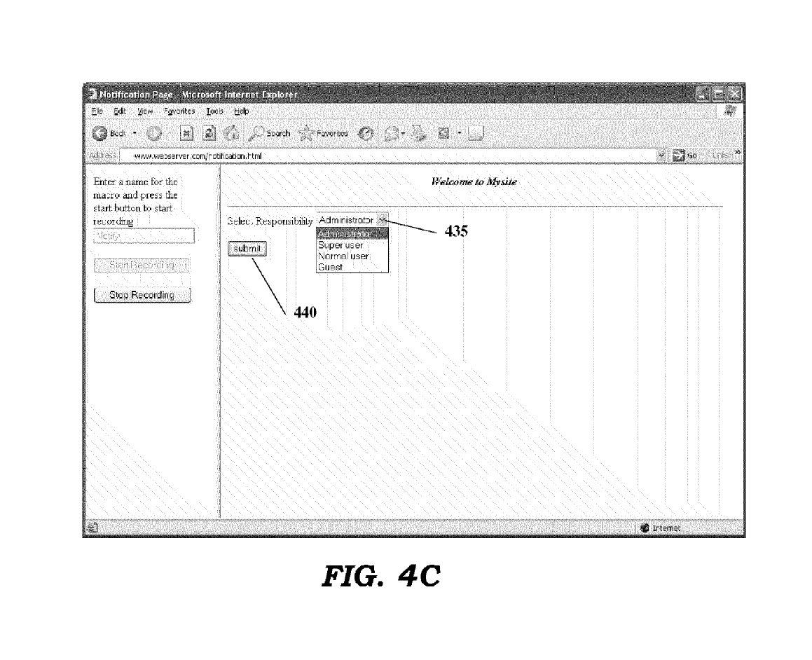

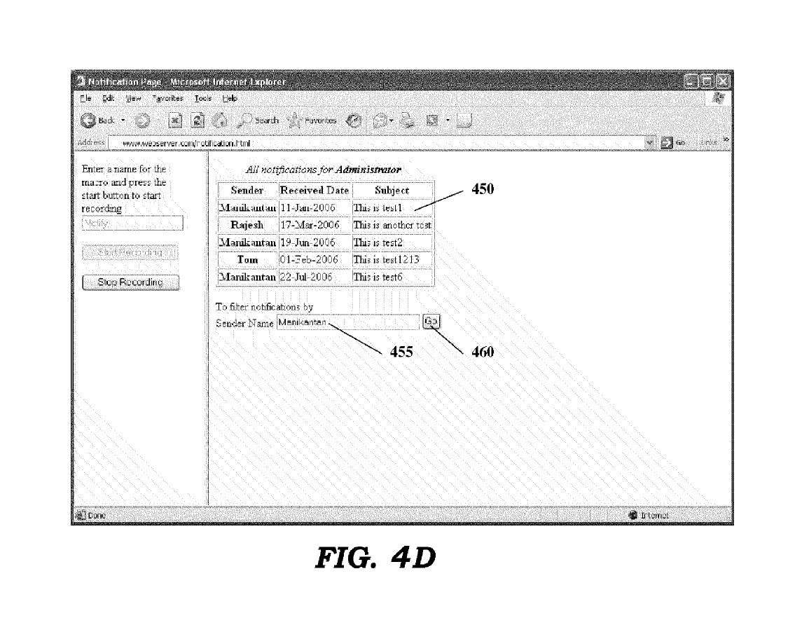

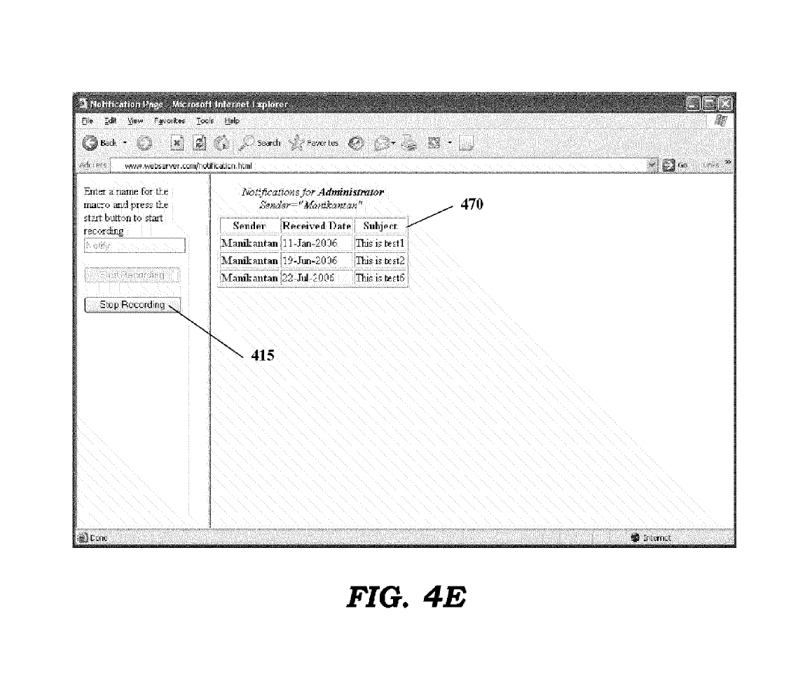

FIGS. 4A, 4B, 4C, 4D and 4E together illustrate the manner in which a user may cause recording of a sequence of user actions. Broadly, the sequence of actions enables a user to access a notification service, provide authentication, select the responsibility/role for which the notifications are to be displayed and filter the notifications based on the sender of the notification. Each of the figures is described in detail below.

FIG. 4A depicts a web page (“www.webserver.com/start.html”) from which a user indicates to a web server to start recording user actions in one embodiment. Text field 405 enables a user to specify a name (“Notify”) for the sequence of user actions to be recorded. Button 410 (labeled “Start Recording”) enables a user to send a request to a web server (identified by “www.webserver.com”, e.g., web server 150) to start recording the user actions. Button 415 (labeled “Stop Recording”) enables a user to indicate to the web server to stop recording the user actions.

FIG. 4B depicts a web page received in response to a user request (“www.webserver.com/notification.html” entered earlier in address field 401 in FIG. 4A) for accessing a notification service on a web server in one embodiment. The web page is shown depicting text field 405 and button 410 in a disabled state, thereby indicating to the user that the web server is recording the user actions.

Button 415 is shown enabled so that the user may stop recording the user actions. Text fields 420 (labeled “User name”) and 425 (labeled “Password”) are used to specify authentication information (“guest” and “pass”) required by the notification service. Submit button 430 enables a user to send a request to the web server for authentication.

On clicking submit button 430, the web browser generates a request in the format “www.webserver.com/login?username=guest&password=pass” where “login” represents the application name and “username” and “password” represent input data required by the application. It may be appreciated that the request may be specified in any format consistent with the implementations of a requesting client application and a responding web server.

FIG. 4C depicts a web page received in response to a user request (sent from the web page depicted in FIG. 4B) for authentication in one embodiment. Selection list 435 (labeled “Select Responsibility”) enables a user to select the responsibility/role for which the notifications are to be displayed. Submit button 440 enables a user to send a request to the web server for displaying the notifications for the selected role (“Administrator”). The request is sent in the format “www.webserver.com/responsibility?role=administrator”.

FIG. 4D depicts a web page received in response to a user request (sent from the web page depicted in FIG. 4C) for displaying the notifications for a selected role in one embodiment. Table 450 displays all the notifications for the role of “Administrator”. Text field 455 (labeled “Sender Name”) enables a user to specify a sender name (“Manikantan”) used to filter the notifications that have been received. Submit button 460 enables a user to send a request to the web server for displaying only the notifications received from a sender. The request is sent in the format “www.webserver.com/filter?sender=Manikantan”.

FIG. 4E depicts a web page received in response to a user request (sent from the web page depicted in FIG. 4D) for displaying only the notifications received from a specified sender in one embodiment. Table 470 displays the notifications for the role of “Administrator” and received from sender “Manikantan”. The user clicks on button 415 to stop recording the user actions. A confirmation web page (not shown) may be displayed to the user indicating confirming the recording of the sequence of user actions.

The description is continued with respect to the commands recorded in response to the various requests noted above.

### 6. Recorded Commands

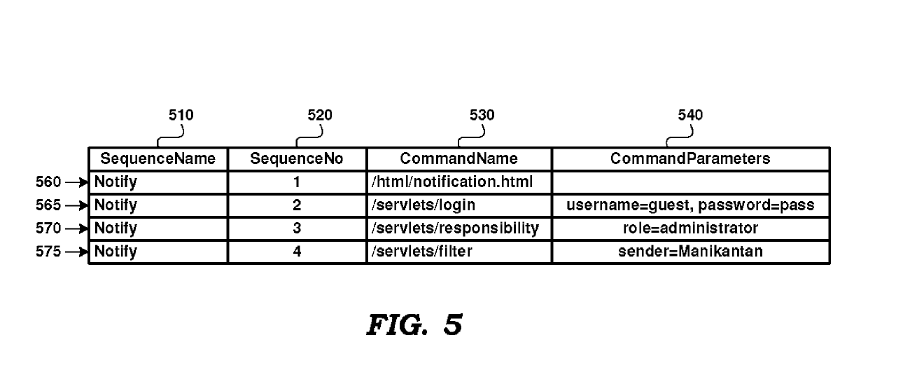

FIG. 5 depicts the commands stored to record user actions in an embodiment. The commands are depicted as being stored in a table in macro database 160. Each of the columns and rows of the table are described below in further detail.

Column 510 (labeled “SequenceName”) identifies the sequence to which the stored commands belong. Different rows having the same “SequenceName” specify the different commands recorded as part of the same sequence. Column 520 (labeled “SequenceNo”) specifies the place of the stored commands in the sequence identified by column 510. The recorded user actions (belonging to the same sequence) may be sorted in an ascending manner by “SequenceNo” to provide the correct sequence of commands that have to be issued to the backend system when replaying the sequence.

Column 530 (labeled “CommandName”) specifies the file name containing the content of a web page or the name of the application that needs to be executed for dynamically generating a web page. Column 540 (labeled “CommandParameters”) specifies the input data specified by the user that may be used by the application (specified in column 530) for generating a web page.

Rows 560, 565, 570, 575 specifies a single sequence of recorded user actions (the “SequenceName” being the same) to be executed in that order (based on the “SequenceNo”). Row 560 depicts the commands to record the user action on receiving a user request (“www.webserver.com/notification.html” entered in FIG. 4A) for accessing a notification service. Column 530 of row 560 identifies the file “/html/notification.html” that is to be retrieved from file system 180.

Row 565 depicts the commands to record the user action on receiving a user request (“www.webserver.com/login?username=guest&password=pass” from FIG. 4B) for authentication. Column 530 of row 565 identifies the web application “/servlets/login” that is to be executed and column 540 of row 565 depicts the input parameters (“username” and “password”) and the corresponding input values (“guest” and “pass”) that may be used by the web application.

Similarly, row 570 depicts the commands to record the user action on receiving a user request (“www.webserver.com/responsibility?role=administrator” from FIG. 4C) for displaying the notifications for a selected role and row 575 depicts the commands to record the user action on receiving a user request (“www.webserver.com/filter?sender=Manikantan” from FIG. 4D) for displaying only the notifications received from a specified sender

Thus, the sequence of user actions performed by a user is recorded at the web server. To repeatedly perform the same sequence of user actions, the user may request the web server to replay the recorded sequence when desired. The example is continued illustrating the manner in which a sequence of recorded user actions is replayed in an embodiment.

### 7. Replay—Illustration

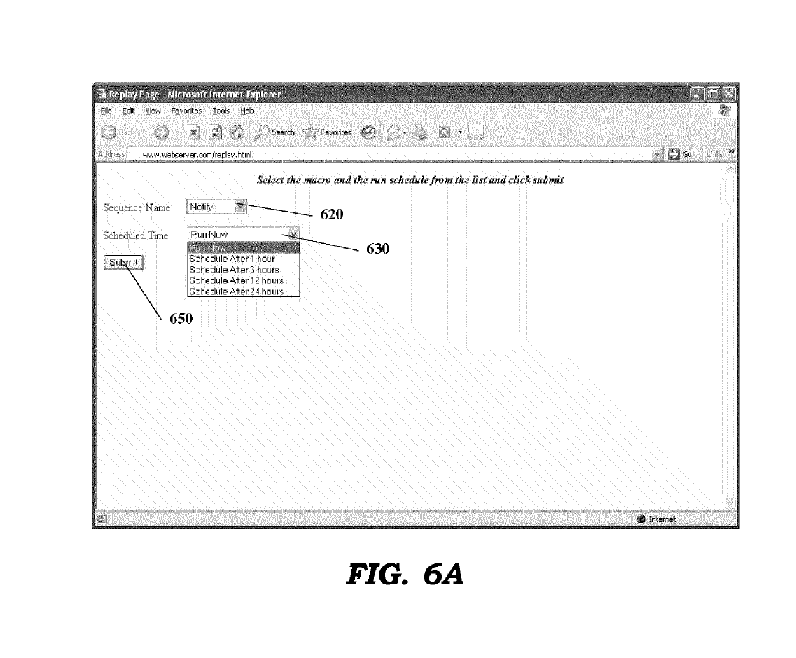

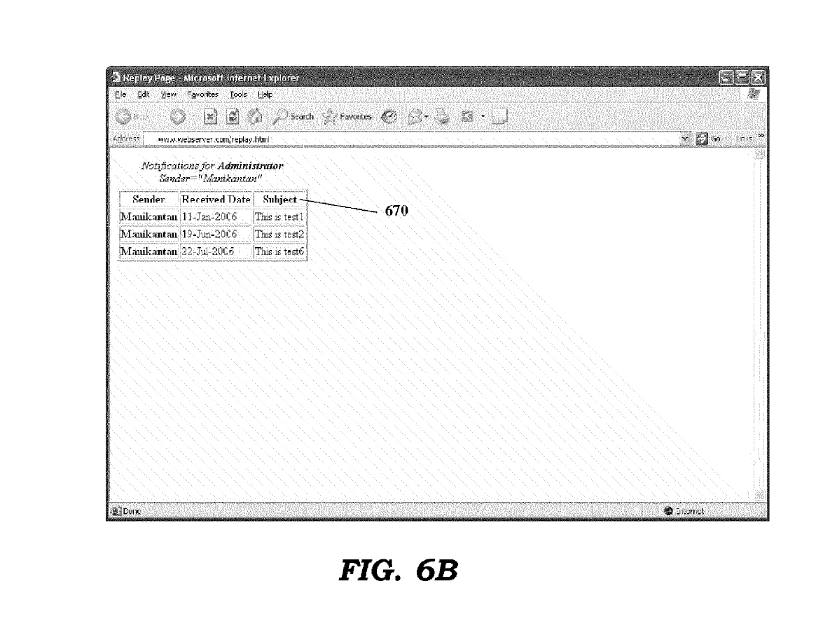

FIGS. 6A, 6B together illustrate the manner in which recorded user actions are replayed in an embodiment. Each of the figures is described in detail below.

FIG. 6A depicts a web page (“www.webserver.com/replay.html”) from which a user requests a web server to replay a sequence of recorded user actions in one embodiment. Selection list 620 (labeled “Sequence Name”) enables a user to select the name (“Notify”) of a sequence of recorded user actions that has to be replayed by the web server. Selection list 630 (labeled “Scheduled Time”) enables a user to select the scheduled time (“Run Now”) when the selected sequence is to be replayed. Submit button 650 enables a user to send a request to the web server for replaying the selected sequence of recorded user actions at the selected scheduled time.

It may be appreciated scheduling enables the user to manage the resources on the web server and also to automate regular tasks that the user requires to be performed on a web server. For example, a user may require that all deleted notifications be permanently removed from the web server at the end of each day. The user records a sequence of user actions, which perform the task of permanently removing deleted notifications. The user then schedules the replay of the recorded sequence at the end of each day, thereby fulfilling the above requirement.

FIG. 6B depicts a web page received in response to a user request (sent from the web page depicted in FIG. 6A) for replaying a sequence of recorded user actions in one embodiment. Table 670 displays the notifications for the role of “Administrator” and received from sender “Manikantan”.

It may be appreciated that the contents of table 670 is substantially similar to the contents of table 470. Thus, replaying the sequence of recorded user actions produces the similar output to executing the sequence of user action manually by the user. A status web page (not shown) may be displayed to the user during replay, indicating the status (e.g., error messages) of replaying the sequence of recorded user actions.

From the above it may be appreciated that web server 150 records the user actions and replays them when so specified by the user. The recording and replaying features can be implemented in various ways using a desired combination of hardware, software and firmware. In an embodiment, the features are implemented as software instructions, as described below in further detail.

### 8. Implementation

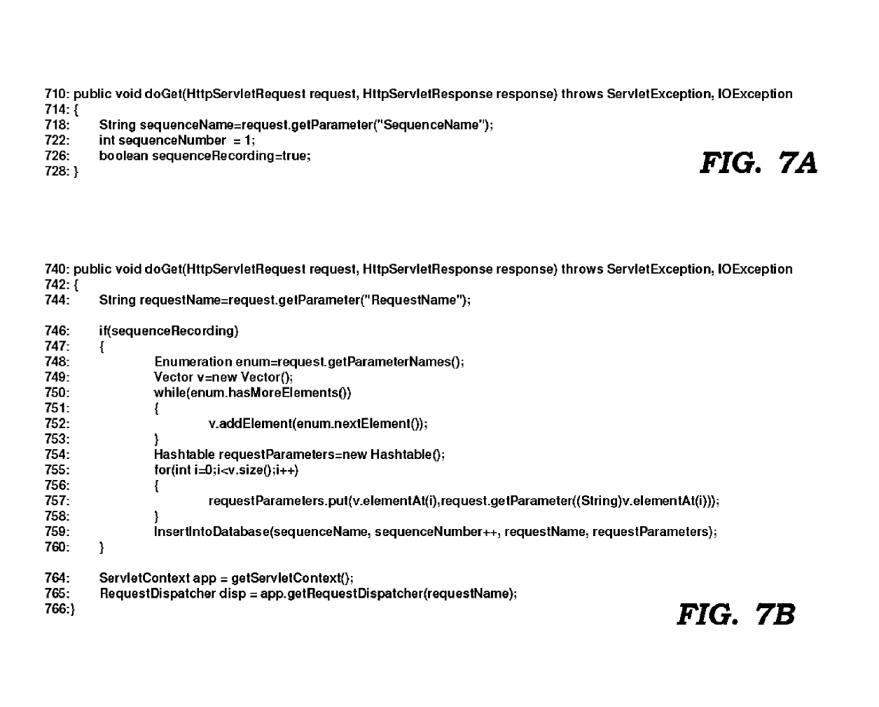

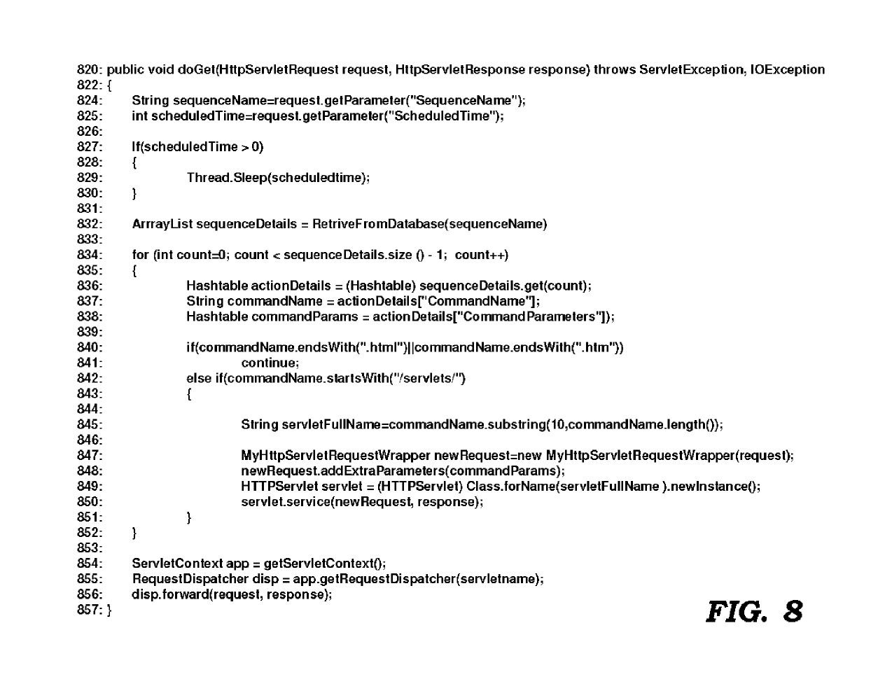

FIGS. 7A, 7B and 8 together illustrate the manner in which user actions performed by a user are recorded and replayed in an embodiment. Each of the figures is described in detail below.

FIG. 7A depicts a portion of software code (executing in a web server) that receives a request (sent from the web page depicted in FIG. 4A) from a user for starting the recording of user actions in an embodiment. In line 718, global variable “sequenceName” is initialized with the value (e.g., “Notify”) specified by the user in text field 405. In line 722, global variable “sequenceNumber” is initialized to “1” indicating the place of the current user action in the sequence of recorded user actions. In line 726, global variable “sequenceRecording” is initialized to “true” indicating that the user actions performed is to be recorded. The global variables indicate the status of recording of user actions to the other portions of code.

It may be appreciated that a different portion of software code (not shown) may be executed when the user indicates that the recording of user actions is to be stopped. The portion of code may contain statements for setting the global variable “sequenceRecording” to “false” thereby stopping the recording of user actions.

FIG. 7B depicts a portion of software code (executing in a web server) that receives requests (sent from the web pages depicted in FIGS. 4B, 4C and 4D) for web pages from a user in an embodiment. In line 744, the variable “requestName” (identifying the command) is initialized with the value of the request name (for example, “/servlets/login”) as determined by web server 150 from the current request specified by the user (“www.webserver.com/login?username=guest &password=pass”). In line 746, the global variable “seqeunceRecording” is checked to determine whether the current request needs to be recorded. In lines 748-758, the request parameters (“username” and “pass”) and their corresponding values (“guest” and “pass”) are retrieved from the request and assigned to the variable “requestParameters” (input data for the command).

In line 759, the user action is recorded by inserting the values of “sequenceName”, “sequenceNumber”, “requestName” and “requestParameters” in a database (160) and the variable “sequenceNumber” is incremented by “1”. In lines 764-765, the request details are forwarded to the request name identified in line 744 for generating the requested web page.

FIG. 8 depicts a portion of software code (executing in a web server) that receives a request (sent from the web page depicted in FIG. 6A) from a user for replaying a sequence of recorded user actions in an embodiment. In line 824, the variable “sequenceName” is initialized with the value of the sequence name (for example, “Notify”) that needs to be replayed as specified by the user in selection list 620. In line 825, the variable “scheduledtime” is initialized with the value of the scheduled time at which the sequence “sequenceName” is to be replayed, as specified by the user in selection list 630.

In lines 826-830, the value of “scheduledtime” is checked to determine whether the specified sequence is to be replayed immediately (when the value is 0) or to be scheduled for a later time. In the scenario where a scheduled time has been specified, the application waits for the scheduled time to be reached. In line 832, the commands corresponding to the sequence identified by “sequenceName” are retrieved from the database (e.g., macro database 160).

In lines 834-852, each of the recorded user actions (except the last action) is performed using the retrieved commands. In lines 836-838, the details of a command corresponding to a single recorded user action is determined from the commands retrieved in line 832. In lines 840-841, the command is checked (by examining the file extension) to determine whether the command specifies static content of a web page. No action is performed if command is determined to be static content and control passes to line 842 otherwise. In line 842, the command is checked to determine the manner (for example, backend system) in which dynamic content is to be generated. Lines 844-850 are executed if dynamic content is to be generated by “servlets” and to Line 852 otherwise.

In lines 844-850, the command is sent to the “servlet” thereby generating the dynamic content of the web page. The command specified by the variable “commandName” (corresponding to column 530 labeled “CommandName”) is used to identify the “servlet” and the variable “commandParameters” (corresponding to column 540 labeled “CommandParameters”) is passed to the identified “servlet” in lines 847-850. It may be appreciated that in line 847, “MyHttpServletRequestWrapper” represents a custom class that may be generated from the “HttpServletRequest” class for example using the following instructions:

```
public class MyHttpServletRequestWrapper extends
HttpServletRequestWrapper { Map params;
  public MyHttpServletRequestWrapper(HttpServletRequest request) {
          super(request);
          this.params = new HashMap(request.getParameterMap( ));
  }
public String getParameter(String name) {
      return (String)params.get(name);
  }
      public void addExtraParameters(Hashtable cmdParams){
          params.putAll(cmdParams);
      }
  }
```

In lines 8853-856, the last recorded user action is performed and the web page generated (such as depicted in FIG. 6B) is sent as the response to the user. It should be appreciated that web server 150 may be implemented in a combination of one or more of hardware, software and firmware. The description is continued with respect to an embodiment in which various features are operative by execution of corresponding software instructions.

### 9. Web Server

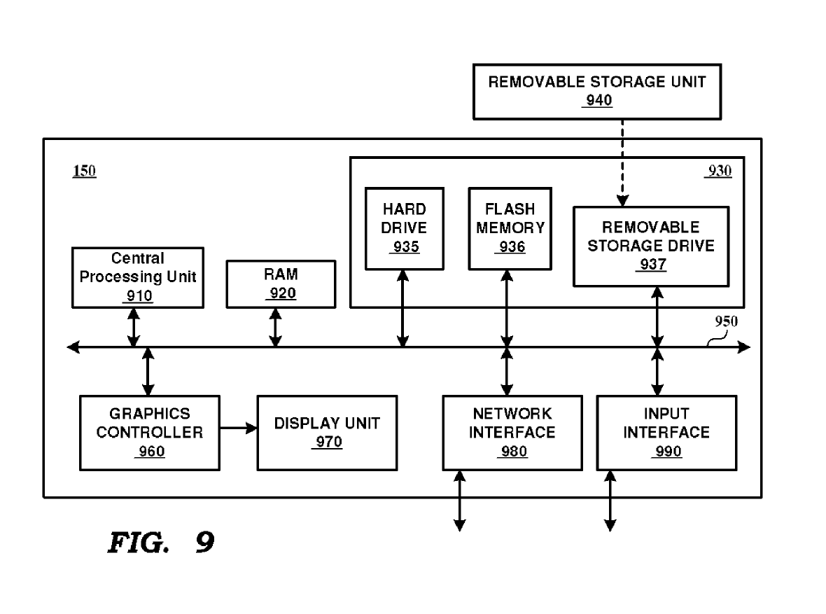

FIG. 9 is a block diagram illustrating the details of web server 150 in one embodiment. Web server 150 may contain one or more processors (such as a central processing unit (CPU) 910), random access memory (RAM) 920, secondary memory 930, graphics controller 960, display unit 970, network interface 980, and input interface 990. All the components except display unit 970 may communicate with each other over communication path 950, which may contain several buses as is well known in the relevant arts. The components of FIG. 9 are described below in further detail.

CPU 910 may execute instructions (e.g., of FIGS. 7A, 7B and 8) stored in RAM 920 to provide several features of the present invention. CPU 910 may contain multiple processing units, with each processing unit potentially being designed for a specific task. Alternatively, CPU 910 may contain only a single general purpose processing unit. RAM 920 may receive instructions and data (e.g., table of FIG. 5) from secondary memory 930 using communication path 950.

Graphics controller 960 generates display signals (e.g., in RGB format) to display unit 970 based on data/instructions received from CPU 910. Display unit 970 contains a display screen to display the images defined by the display signals. Input interface 990 may correspond to a keyboard and/or mouse. Network interface 980 provides connectivity to a network (e.g., using Internet Protocol), and may be used to communicate with other systems (e.g., client systems 110-A to 110-C and backend systems 180 and 190) of FIG. 1.

Secondary memory 930 may contain hard drive 935, flash memory 936 and removable storage drive 937. Secondary memory 930 may store the data (e.g., table of FIG. 5) and software instructions (e.g., portions of software code), which enable system 900 to provide several features in accordance with the present invention. Some or all of the data and instructions may be provided on removable storage unit 940, and the data and instructions may be read and provided by removable storage drive 937 to CPU 910. Floppy drive, magnetic tape drive, CD-ROM drive, DVD Drive, Flash memory, removable memory chip (PCMCIA Card, EPROM) are examples of such removable storage drive 937.

Removable storage unit 940 may be implemented using medium and storage format compatible with removable storage drive 937 such that removable storage drive 937 can read the data and instructions. Thus, removable storage unit 940 includes a computer readable storage medium having stored therein computer software and/or data.

In this document, the term “computer program product” is used to generally refer to removable storage unit 940 or hard disk installed in hard drive 935. These computer program products are means for providing software to web server 150. CPU 910 may retrieve the software instructions, and execute the instructions to provide various features of the present invention described above.

### 10. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of facilitating replay of desired sequences of user actions, said method being performed in a web server designed to receive requests for web pages and send the requested web pages, said method comprising:
receiving an indication to record a sequence of user actions;
receiving a plurality of requests from a user, wherein each of said plurality of requests corresponds to a corresponding one of said sequence of user actions and specifies a corresponding web page;
translating said plurality of requests to a plurality of commands, wherein said plurality of commands are designed to generate said corresponding web pages by interfacing with backend systems providing content for said web pages; and
storing said plurality of commands in a memory.

2. The method of claim 1, further comprising:
determining a time to replay said sequence of user actions;
retrieving said plurality of commands from said memory; and
issuing said plurality of commands to said backend systems to replay said sequence of user actions.

3. The method of claim 2, wherein said issuing generates a last web page, wherein said last web page is designed to be generated in response to a last user action contained in said sequence of user actions, said method further comprising sending said last web page to said user.

4. The method of claim 3, further comprising receiving a schedule time at which said sequence of user actions is to be replayed, wherein said time is determined to equal said schedule time.

5. The method of claim 1, further comprising:
receiving each of said web pages from said backend systems by issuing corresponding subset of said plurality of commands to said backend systems;
sending each of said received web pages to said user; and
receiving a next one of said plurality of requests after said sending of the generated web page.

6. The method of claim 1, wherein said memory comprises a non-volatile storage and wherein said plurality of commands are stored in a table containing a first column indicating a command name and a second column indicating a parameter provided by said user for the request.

7. The method of claim 6, wherein said backend systems comprises a file system containing a plurality of files and said content for said web pages are stored in said plurality of files.

8. The method of claim 6, wherein said backend systems comprises a web application designed to generate said content of said web pages.

9. A computer readable medium carrying one or more sequences of instructions for causing a web server to facilitate replay of desired sequences of user actions, wherein said web server is designed to receive requests for web pages and send the requested web pages, wherein execution of said one or more sequences of instructions by one or more processors contained in said web server causes said one or more processors to perform the actions of:
receiving an indication to record a sequence of user actions;
receiving a plurality of requests from a user, wherein each of said plurality of requests corresponds to a corresponding one of said sequence of user actions and specifies a corresponding web page;
translating said plurality of requests to a plurality of commands, wherein said plurality of commands are designed to generate said corresponding web pages by interfacing with backend systems providing content for said web pages; and
storing said plurality of commands in a memory.

10. The computer readable medium of claim 9, further comprising one or more instructions for:
determining a time to replay said sequence of user actions;
retrieving said plurality of commands from said memory; and
issuing said plurality of commands to said backend systems to replay said sequence of user actions.

11. The computer readable medium of claim 10, wherein said issuing generates a last web page, wherein said last web page is designed to be generated in response to a last user action contained in said sequence of user actions, said computer readable medium further comprising one or more instructions for sending said last web page to said user.

12. The computer readable medium of claim 11, further comprising one or more instructions for receiving a schedule time at which said sequence of user actions is to be replayed, wherein said time is determined to equal said schedule time.

13. The computer readable medium of claim 9, further comprising one or more instructions for:
receiving each of said web pages from said backend systems by issuing corresponding subset of said plurality of commands to said backend systems;
sending each of said received web pages to said user; and
receiving a next one of said plurality of requests after said sending of the generated web page.

14. The computer readable medium of claim 9, wherein said memory comprises a non-volatile storage and wherein said plurality of commands are stored in a table containing a first column indicating a command name and a second column indicating a parameter provided by said user for the request.

15. The computer readable medium of claim 14, wherein said backend systems comprises a file system containing a plurality of files and said content for said web pages are stored in said plurality of files.

16. The computer readable medium of claim 14, wherein said backend systems comprises a web application designed to generate said content of said web pages.

17. An apparatus facilitating replay of desired sequences of user actions, said apparatus being contained in a web server designed to receive requests for web pages and send the requested web pages, said apparatus comprising:
means for receiving an indication to record a sequence of user actions;
means for receiving a plurality of requests from a user, wherein each of said plurality of requests corresponds to a corresponding one of said sequence of user actions and specifies a corresponding web page;
means for translating said plurality of requests to a plurality of commands, wherein said plurality of commands are designed to generate said corresponding web pages by interfacing with backend systems providing content for said web pages; and
means for storing said plurality of commands in a memory.

18. The apparatus of claim 17, further comprising:
means for determining a time to replay said sequence of user actions;
means for retrieving said plurality of commands from said memory; and
means for issuing said plurality of commands to said backend systems to replay said sequence of user actions.

19. The apparatus of claim 18, wherein said means for issuing generates a last web page, wherein said last web page is designed to be generated in response to a last user action contained in said sequence of user actions, said apparatus further comprising means for sending said last web page to said user.

20. The apparatus of claim 19, further comprising means for receiving a schedule time at which said sequence of user actions is to be replayed, wherein said time is determined to equal said schedule time.

21. The apparatus medium of claim 17, further comprising:
means for receiving each of said web pages from said backend systems by issuing corresponding subset of said plurality of commands to said backend systems;
means for sending each of said received web pages to said user; and
means for receiving a next one of said plurality of requests after said means for sending sends the generated web page.

22. The apparatus of claim 17, wherein said memory comprises a non-volatile storage and wherein said plurality of commands are stored in a table containing a first column indicating a command name and a second column indicating a parameter provided by said user for the request.

23. The apparatus of claim 22, wherein said backend systems comprises a file system containing a plurality of files and said content for said web pages are stored in said plurality of files.

24. The apparatus of claim 22, wherein said backend systems comprises a web application designed to generate said content of said web pages.
